(19) United States
(12) Patent Application Publication
(10) Pub. No.: US 2008/0102665 A1
(43) Pub. Date: May 1, 2008

(54) Electrical connector assembly with improved pick up cap

(75) Inventor: Chia-Wei Fan, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/980,975

(22) Filed: Oct. 31, 2007

(30) Foreign Application Priority Data
Oct. 31, 2006 (CN) 200620126669.6

(51) Int. Cl. H01R 13/447

(52) U.S. Cl. 439/135

(57) ABSTRACT

An electrical connector assembly (5) includes an electrical connector (6) and a pick up cap (7) latchably assembled to the electrical connector. The electrical connector includes an insulative housing (60) and a number of conductive contacts received in the insulative housing. The pick up cap includes a main portion (70) and a pick up portion (71) protruding upwardly form middle area of the main portion, and a depressed recess (700) formed below the pick up portion. The depressed recess is formed with a plurality of ribs (703).

### BACKGROUND OF THE INVENTION

1. Field of the Invention

The present invention generally relates to an electrical connector assembly, and more particularly to an electrical connector assembly for removably mounting a chip module to a printed circuit board.

2. Description of Related Art

Please refer to FIGS. 1-2, a conventional electrical connector assembly 1 for electrically connecting a chip module (not shown) to a printed circuit board (not shown) is widely used in electrical equipments. The electrical connector assembly 1 usually comprises an electrical connector 2 and a pick up cap latchably assembled to the electrical connector. The pick up cap 3 comprises a main portion 30 and a pick up portion 31 protruding outwardly from middle area of the main portion 30. The pick up portion 31 has a smooth top surface 310 capable of being vacuumed by a vacuum device to realize the movement and position of the electrical connector 2.

However, the electrical connector assembly with above structures has at least the shortcomings as follows: In the process of the movement and position of the electrical connector 2, the pick up portion 31 must have certain height to assure the finish of the vacuum action and the action of positioning the electrical connector 2 to the printed circuit board, therefore, the pick up portion 31 usually directly protrudes upwardly from the main portion 30 for being vacuumed by the vacuum device and a depressed recess 300 is formed below the pick up portion 31. Thus, the main portion 30 of the pick up cap 3 has different thicknesses and has great possibility of instability of constriction when cooling after molding which causes the deformation of the pick up cap 3, which further causes the unsmooth of the top surface 310. Obviously, the vacuum device cannot finish the vacuum action and the action of positioning the electrical connector 1 to the printed circuit board.

Therefore, it is desired to provide an improved electrical connector assembly to stress the problems mentioned above.

### BRIEF SUMMARY OF THE INVENTION

Accordingly, an object of the present invention is to provide an electrical connector assembly with improved structure for preventing the deformation of a pick up cap thereof.

In order to achieve the above-mentioned object, an electrical connector assembly comprises an electrical connector and a pick up cap latchably assembled to the electrical connector. The electrical connector comprises an insulative housing and a plurality of conductive contacts received in the insulative housing. The pick up cap comprises a main portion and a pick up portion protruding upwardly form middle area of the main portion, and a depressed recess formed below the pick up portion. The depressed recess is formed with a plurality of ribs.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of a conventional electrical connector assembly;

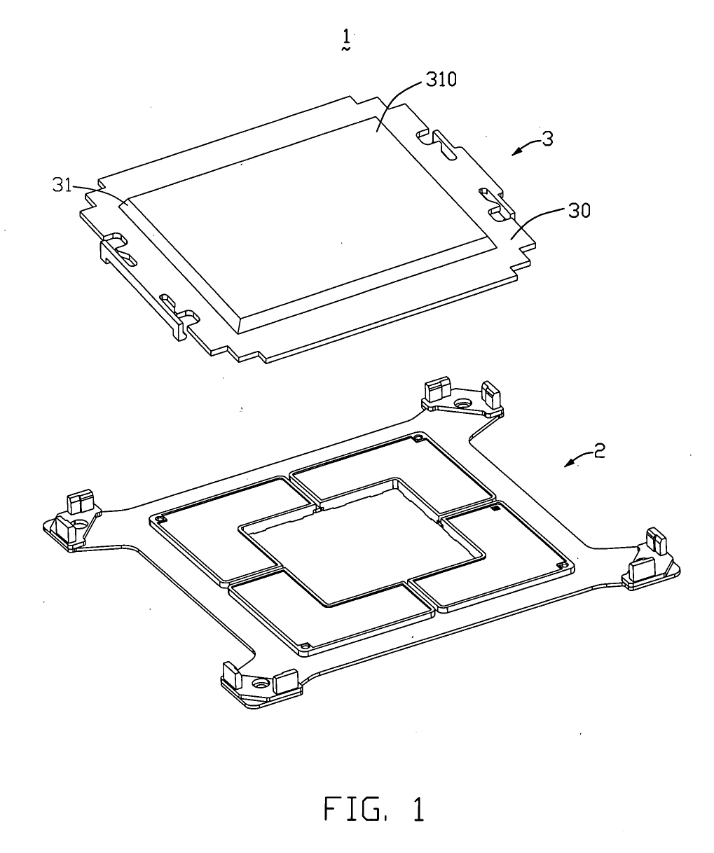

FIG. 2 is a bottom view of a pick up cap shown in FIG. 1;

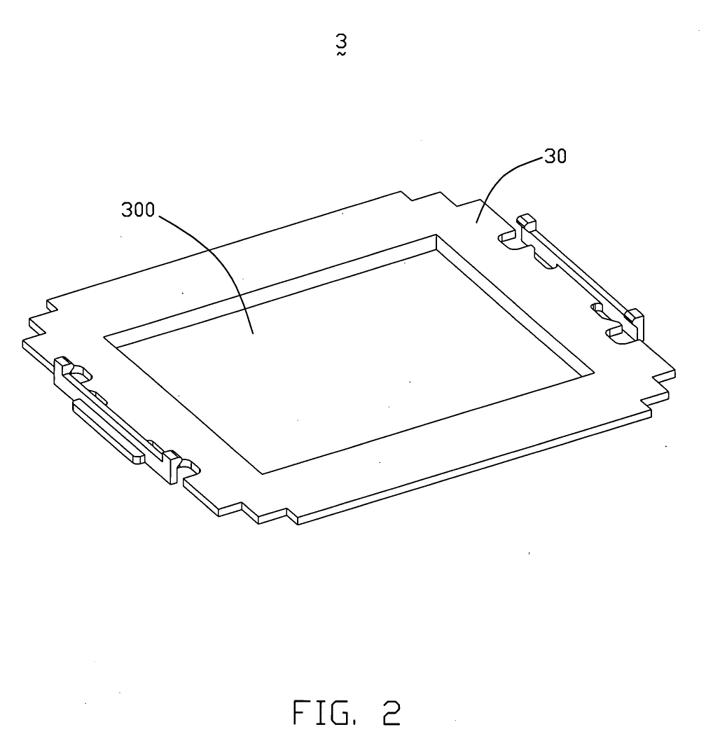

FIG. 3 is an exploded, perspective view of an electrical connector assembly in accordance with the present invention; and

FIG. 4 is a bottom view of a pick up cap shown in FIG. 3.

### DETAILED DESCRIPTION OF THE INVENTION

Reference will now be made to the drawing figures to describe the present invention in detail.

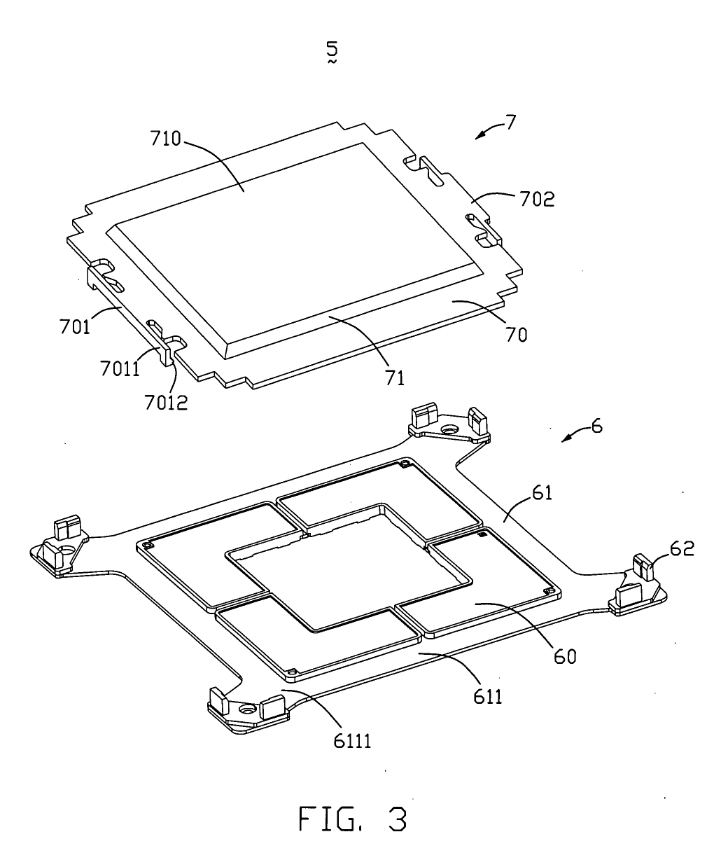

Please refer to FIG. 3, an electrical connector assembly 5 in accordance with the present invention for electrically connecting a chip module (not shown) to a printed circuit board comprises an electrical connector 6 and a pick up cap 7 latchably assembled to the electrical connector 6. The electrical connector 6 comprises an insulative housing 60 assembled with a plurality of conductive contacts (not shown), a fastening frame 61 partially surrounding the insulative housing 60 and a plurality of restriction tubes 62 formed on the fastening frame 61.

The insulative housing 60 is a flat board and defines a plurality of contact-receiving slots (not shown) penetrating through opposite upper and lower surfaces thereof. Each contact-receiving slot receives a corresponding conductive contact.

The fastening frame is also a flat board and comprises a plurality of side edges 611 each comprising a supporting surface 6111 equipped with the restriction tubes 62.

The pick up cap 7 is substantially of flat board and comprises a main portion 70 and a pick up portion 71 protruding upwardly from the main portion 70. The pick up portion 71 has a smooth top surface 710 for being vacuumed by a vacuum device (not shown) to realize the movement and position of the electrical connector 6.

The main portion 70 has a pair of latching portions 701 downwardly extending from opposite ends thereof to latch with the electrical connector 6. Each latching portion 701 has a connection section 7011 connecting with the main portion 70, and a pair of hooks 7012 formed at opposite ends of the connection section 7011 latchably assembled to the fastening frame 61 for retaining the pick up cap 7 to the electrical connector 6. A tongue section 702 horizontally and outwardly extends from one connection section 7011 for separating the pick up cap 7 from the electrical connector 6.

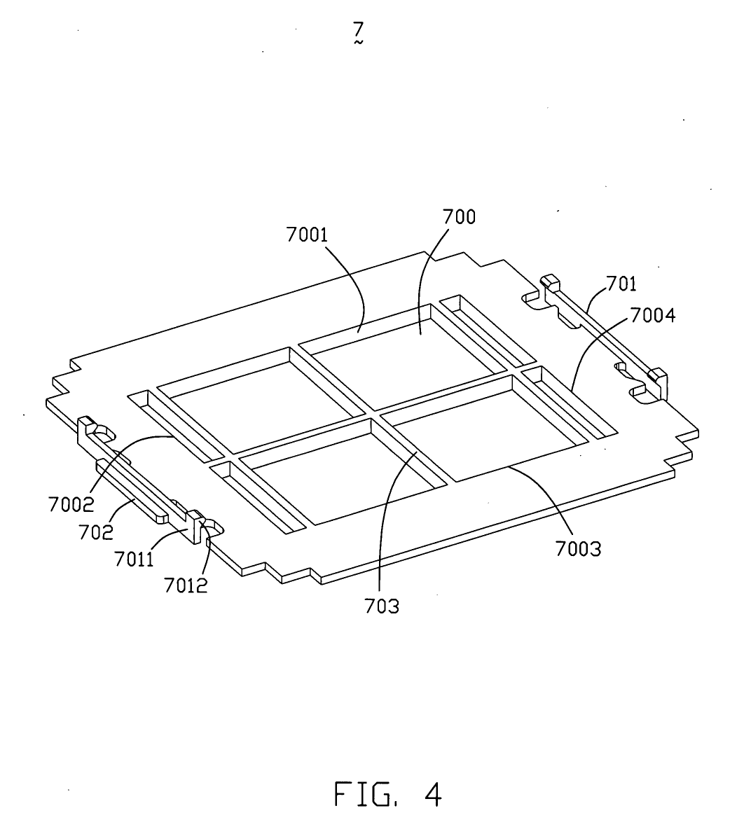

Please refer to FIG. 4, a depressed recess 700 is formed below the pick up portion 71 and ahs the same configuration as that of the top surface 710. The depressed recess 700 comprises a first sidewall 7001, a second sidewall 7002, a third sidewall 7003 and a fourth sidewall 7004 connecting with one another. A plurality of ribs 703 is formed in the depressed recess 700. Each rib 703 can extend from one sidewall, such as the first sidewall 7001, to opposite sidewall, such as the third sidewall 7003. Each rib 703 also can extend from one sidewall to another sidewall connecting with the one sidewall. The bottom surfaces of the ribs 703 are coplanar with the bottom surface of the main portion 70. In the preferred embodiment of the present invention, the ribs 703 are arranged to be like a window.

In assembly, the pick up cap 7 is latchably assembled to the electrical connector 6 via the latching portions 701. The vacuum device may vacuum the pick up cap 7 to realize the movement and position of the electrical connector 6. Since the existence of the ribs 703 in the depressed recess 700, the main portion 70 of the pick up cap 7 is enhanced and the deformation when molding of the pick up cap 7 is also decreased. A smooth top surface 710 with desired flatness is thus achieved and the movement and position of the electrical connector 6 is finished by the vacuum device successfully.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
an electrical connector, comprising:
an insulative housing; and
a plurality of conductive contacts received in the insulative housing; and
a pick up cap latchably assembled to the electrical connector and comprising a main portion and a pick up portion protruding upwardly form middle area of the main portion, and a depressed recess formed below the pick up portion; and wherein
the depressed recess is formed with a plurality of ribs.

2. The electrical connector assembly as claimed in claim 1, wherein the depressed recess is surrounded by four sidewalls connecting with one another, and wherein each rib connects a pair of opposite sidewalls.

3. The electrical connector assembly as claimed in claim 1, wherein the depressed recess is surrounded by four sidewalls connecting with one another, and wherein each rib connects two adjacent sidewalls.

4. The electrical connector assembly as claimed in claim 1, wherein bottom surfaces of the ribs are substantially coplanar with the bottom surface of the main portion.

5. The electrical connector assembly as claimed in claim 1, wherein the pick up portion has a smooth top surface, and wherein the shape of the depressed recess is substantially same as that of the smooth top surface.

6. The electrical connector assembly as claimed in claim 1, further comprising a fastening frame partially surrounding the insulative housing and latchably engaging with the pick up cap.

7. The electrical connector assembly as claimed in claim 6, wherein the fastening frame forms a plurality of restriction ribs at four corners.

8. The electrical connector assembly as claimed in claim 6, wherein the main portion of the pick up cap forms a pair of latching portions latching with opposite edges of the fastening frame.

9. The electrical connector assembly as claimed in claim 1, wherein the main portion of the pick up cap forms a pair of latching portions downwardly extending therefrom to latch with the electrical connector.

10. The electrical connector assembly as claimed in claim 9, wherein the main portion of the pick up cap forms a tongue section flatly extending therefrom for separating the pick up cap from the electrical connector conveniently.

11. The electrical connector assembly as claimed in claim 10, wherein the tongue section extends outwardly from one latching portion.

12. An electrical connector assembly comprising:
an electrical connector including:
an insulative housing;
a plurality of contacts disposed in the housing;
a pick up cap attached to the connector and covering a top face of the connector; wherein
said pick up cap includes a periphery region and a center suction region defining an upward suction face thereon and being offset from the periphery region in a vertical direction so as to form a recess therein, and one rib on an opposite face of the center section region under a condition that said rib is connected to the periphery region.

13. The electrical connector assembly as claimed in claim 12, wherein a bottom face of the rib is essentially coplanar with a bottom face of said periphery region.

14. The electrical connector assembly as claimed in claim 12, wherein said suction region is higher than the periphery region.
